(19) United States
(12) Patent Application Publication
(10) Pub. No.: US 2016/0170527 A1
(43) Pub. Date: Jun. 16, 2016

(54) MULTI-FUNCTIONAL MAN-MACHINE INTERACTIVE SYSTEM AND COMMUNICATION METHED THEREFOR

(71) Applicant: JIAOTU CO., LTD., Suzhou, Jiangsu (CN)

(72) Inventors: Gang ZHONG, Suzhou City, Jiangsu (CN); Ruijun Zhang, Guiyang, Guizhou (CN); Jie Zhou, Wuhan City, Hubei (CN)

(73) Assignee: JIAOTU CO., LTD., Suzhou, Jiangsu (CN)

(21) Appl. No.: 14/908,000

(22) PCT Filed: Aug. 13, 2014
(86) PCT No.: PCT/CN2014/084272

§ 371 Date: Jan. 27, 2016

(30) Foreign Application Priority Data
Aug. 13, 2013 (CN) 201310351107.6

(51) Int. Cl. G06F 3/044

(52) U.S. Cl. CPC G06F 3/044; G06F 2203/04102

(57) ABSTRACT

Disclosed are a multi-functional man-machine interactive system and a communication method therefor. The system comprises an application software module, a drive chip and a man-machine interactive panel, wherein the application software module comprises application software which performs induction signal transmission based on a KISS system; the man-machine interactive panel comprises several electrically conductive material routings, the electrically conductive material routings being used for sending and receiving induction signals; and the drive chip comprises a touch control chip and/or a display drive chip. In the present invention, by using a man-machine interactive panel provided with electrically conductive material routings as a transmitting/receiving end, signals are small, so that the security can be guaranteed. In addition, the man-machine interactive panel has been widely applied to mobile devices, so that secure wireless data transmission communications can be realized without additionally adding chips and antennas.

The application claims priority benefit from Chinese Patent No. 201310351107.6 submitted to the Patent Office of the People's Republic of China on Aug. 13, 2013, and entitled “multi-functional man-machine interactive system and communication method therefor”, the entire contents of which are incorporated herein by reference.

### FIELD OF THE INVENTION

The invention relates to the field of photoelectricity and communication technology, and more particular to a multi-functional man-machine interactive system and a communication method therefortherefor.

### BACKGROUND

Around 2003, Philips semiconductor and Sony Company planned to develop a wireless communication technology that was compatible with the non-contact card technology based on the non-contact card technology. It is a technology that can quickly establish the communication in an equipment room.

NFC is abbreviated from Near Field Communication, i.e., near field communication technology. The NFC jointly developed by Philips Company and Sony Company is a non-contact recognition and interconnection technology, which can perform near field communication in mobile device, consumer electronics, PC and smart control tool room. The NFC provides a simple, touch type solution, which can prompt the consumer to simply and directly exchange information, and to access content and service, such as bus card, card type access control system, and mobile payment, etc.

For the existing communication technology, and for the NFC, its function is single and the communication speed is not so fast; therefore, it fails to be used in a smart phone without a NFC chip system.

The speed of the Bluetooth communication is faster, but it is slower to establish the communication, and the connection establishment needs more than 5 seconds. Due to its openness, it is easy to catch and decode. In this way, the safety is worse.

In addition, the touch device is not provided with the communication function, an active capacitive pen and a capacitive screen only scan in allusion to a signal unidirectionally transmitted by the capacitive touch screen to judge the touch position, without data exchange.

Therefore, in allusion to the above technical problems, the invention discloses a KISS (Keycode Interflow Sensor System) technology that is different from the NFC, as well as a multi-functional man-machine interactive system and a communication method therefor that apply the technology.

### SUMMARY OF THE INVENTION

On that account, the object of the invention is to provide a multi-functional man-machine interactive system capable of performing man-machine interactive, inductive transmission and display as well as a communication method therefor.

In order to achieve the above object, the technical scheme provided in the embodiment of the invention is as follows:

A multi-functional man-machine interactive system comprises an application software module, a drive chip and a man-machine interactive panel, wherein the application software module comprises application software performing signal induction and transmission based on a KISS system, the man-machine interactive panel comprises a plurality of electrically conductive material routing, the electrically conductive material routing is used for transmitting and receiving an induction signal, and the drive chip comprises a touch control chip and/or a display drive chip.

As further improvement of the invention, the man-machine interactive panel comprises a flexible or non-flexible touch screen and a display screen.

As further improvement of the invention, the man-machine interactive panel comprises a capacitive touch screen and a resistive touch screen, the touch panel comprises a capacitive touch panel and a resistive touch panel, and the display screen comprises an LCD (Liquid Crystal Display).

As further improvement of the invention, the electrically conductive material routing comprises ITO material routing, metal routing and carbon nanomaterial routing.

As further improvement of the invention, the electrically conductive material routing is further used for detecting the touch position by means of the signal change on the routing when the man-machine interactive panel is the touch screen and the touch panel; and the electrically conductive material routing is further used for displaying the stimulation of the driving signal to change the image of the display screen when the man-machine interactive panel is the display screen.

Correspondingly, a communication method of the multi-functional man-machine interactive system comprises the following steps of:

S1. turning on two man-machine interactive systems needing to communicate and opening the application software on the system;

S2. enabling the man-machine interactive panels of the two systems to be close to each other, transmitting a communication request signal through the electrically conductive material and receiving a communication request signal of another system at the same time, receiving a signal of another signal through the transmission of the induction signal, judging whether searching the communication request signal of the system needing connection establishment, if so, performing step S3, and if not, re-performing step S2;

S3. synchronizing a clock signal to establish the connection between two systems;

S4. performing signal transmission and signal reception between two systems; and

S5. after successfully establishing the communication, emitting an alert signal through the communication application, prompting the successful communication establishment, completing the communication, and separating the two communication systems from each other.

As further improvement of the invention, the “signal transmission” of the transmitting system in the step S4 specifically comprises the following sub-steps of:

acquiring the communication signal of the application software needing to transmit, and transmitting the communication signal to the drive chip; and

transmitting the communication signal to the electrically conductive material routing in the man-machine interactive panel through the drive chip, and performing the signal transmission through the electrically conductive material routing.

As further improvement of the invention, the “signal reception” of the receiving system in the step S4 specifically comprises the following sub-steps of:

receiving the communication signal of the man-machine interactive panel on another system through the electrically conductive material routing in the man-machine interactive panel; and

transmitting the communication signal to the drive chip, and transmitting to the application software through the drive chip.

As further improvement of the invention, the step S2 specifically comprises the following sub-steps of:

enabling the two systems needing to communicate to be close to each other, transmitting the communication request signal respectively through two communication systems, receiving the communication request signal of the opposite side respectively through two communication systems at the same time, and judging the researched system needing connection establishment if both two communication systems receive the receiving signal of the opposite side.

As further improvement of the invention, the step S5 specifically comprises the following sub-steps of:

separating the two communication systems from each other, judging whether the two communication systems receive the connecting signal from the opposite side in the separation process, judging the two systems have been separated when the connecting signal is degraded and fails to receive, breaking off the communication, and emitting the alert signal through the system to prompt the communication outage.

The invention has the beneficial effects as follows:

The multi-functional man-machine interactive system and the communication method therefor according to the invention use the man-machine interactive panel with the electrically conductive material routing as a transmitting/receiving end, the signal is small and the safety can be guaranteed; in addition, the man-machine interactive panel has been widely applied on a mobile device, and the safe wireless data transmission communication can be achieved without additional chips.

### BRIEF DESCRIPTION OF THE DRAWINGS

In order to more clearly illustrate the embodiments of the invention or the technical scheme in the prior art, the embodiments or the drawings as required to use in the description of the prior art are simply introduced hereinafter. Obviously, the drawings in the description hereinafter are only some embodiments recorded in the invention. Those common skilled in the art can further acquire other drawings according to these drawings at the premise without giving creative work.

FIG. 1 is a schematic structural drawing of a multi-functional man-machine interactive system according to the invention;

FIG. 2 is a schematic drawing for communication of a multi-functional man-machine interactive system according to the invention; and

FIG. 3 is a flow diagram of communication method of a multi-functional man-machine interactive system according to the invention.

### DETAILED DESCRIPTION

In order to promote those skilled in the art to better understand the technical scheme in the invention, the technical scheme in the embodiments of the invention is clearly and completely described hereinafter with reference to the drawings in the embodiments of the invention. Obviously, the described embodiment is only part of the embodiments of the invention, rather than all embodiments. Based on the embodiments of the invention, all other embodiments acquired by those common skilled in the art at the premise without creative work shall pertain to the scope of the protection of the invention.

See FIG. 1, the multi-functional man-machine interactive system in the invention comprises an application software module 11, a drive chip 12 and a man-machine interactive panel 13. Wherein:

The application software module 11 comprises application software performing signal induction and transmission based on a KISS system, the KISS is a man-machine interactive induction and transmission system, and the signal of the application software can perform the induction and transmission through the KISS system.

The drive chip 12 comprises a touch control chip and/or a display drive chip, and the drive chip is further integrated with a controller (without being shown in figure) for controlling the touch control chip when the drive chip is touch control chip; the drive chip is further integrated with a control function of controlling the display screen when the drive chip is the display drive chip;

The man-machine interactive panel 13 comprises the plurality of electrically conductive material routing. The electrically conductive material routing is used for transmitting the signal, preferably, the electrically conductive material routing in the embodiment is selected from the ITO routing, and the other embodiments can also be selected from the metal routing, the carbon nanomaterial routing and the like.

Here, the chip driving the electrically conductive material is the drive chip that needs to make some modifications for the sending signal and the receiving signal. These drive chips send the signals for the electrically conductive materials according to the need after completing the original driving ability and process the received signal and transmit the signals to the system.

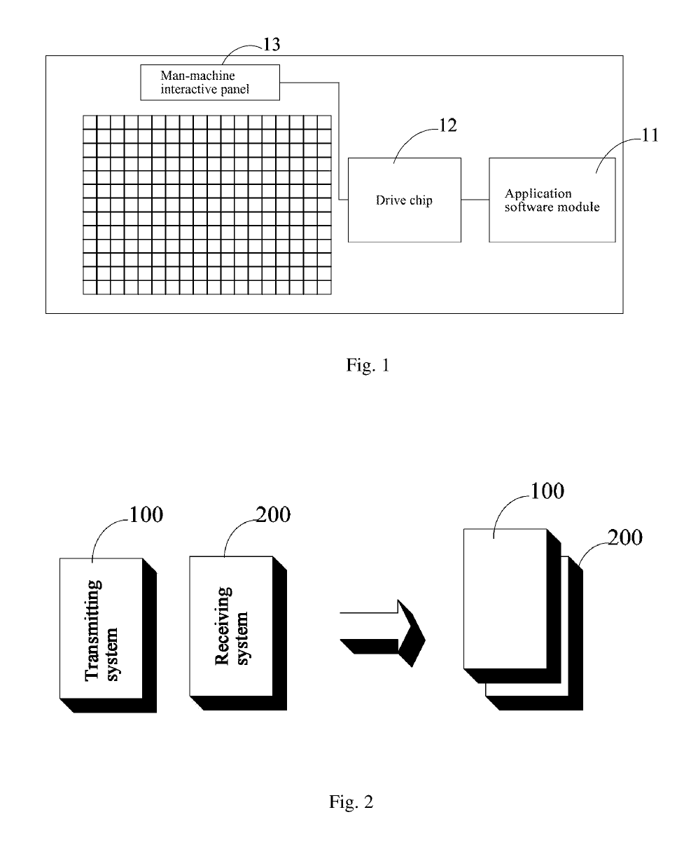

When communicating, the multi-functional man-machine interactive system in the invention comprises a transmitting system for transmitting a signal and a receiving system for transmitting a signal, the transmitting system is one or more man-machine interactive systems, similarly, the receiving system is also one or more man-machine interactive systems. As shown in FIG. 2, the transmitting system 100 and the receiving system 200 are overlapped face-to-face during communication, so that the touch screen is overlapped and then communicates.

The multi-functional man-machine interactive system (transmitting system and/or receiving system) in the invention can be achieved as an independent or separate device, or can be combined in or coupled to another electrical device or application software device, such as mobile phone, portable computing device, other computing device (such as person, laptop or desktop computer), computer peripheral (such as printer), portable audio and/or video player, payment system, ticket service writing system (such as, parking ticket system, bus ticket system, train ticket system or admission ticket system), or the communication device can be included in a ticket reading system, toys, game machine, poster, package, advertise material, product inventory checking system and/or any other suitable electronic device obvious for the technical staffs in the relevant fields in a condition without departing from the spirit and scope of the invention. This means any interactive interface which needs man touch operation or gives hints in some mode for the man. The more complicated is ATM terminal device, while the simpler is the switch of the light, the characteristic is that there are electrically conductive material routings in the interface. An electric field with equivalent capacitance is formed in another closer man-human interactive interface; the alternating current frequency signal can be sent and received between two electrodes of the capacitance. For example, the surfaces of two mobile phones are made of liquid crystal display (LCD) screen (touch screen), when two mobile phones are adhered to each other face-to-face, the equivalent capacitance is formed between two mobile phones' LCD screens (touch screens). When the signal is sent from the LCD screen (touch screen) of the mobile phone, the signal is received by the LCD screen (touch screen) of the other mobile phone, which is equal to an equivalent circuit transmitting the signal from one end electrode of the capacitance to the other end electrode of the capacitance.

The man-machine interactive panel in the multi-functional man-machine interactive system according to the invention comprises a flexible or non-flexible touch screen, touch plate, display screen or other man-machine interactive panel with the electrically conductive material routing, further, the touch screen comprises a capacitive touch screen and a resistive touch screen, the touch plate comprises a capacitive touch plate and a resistive touch plate, and the display screen comprises the LCD. The drive chiof of the existing resistance screen drives the electrically conductive material on the surface of the resistance screen to measure the parameter change caused by receiving the surrounding contact by the electrically conductive material; the drive chip does not have the processing ability to the outside man-human interactive interface transmitting signal and receiving signal, so the chip needs to be modified to execute the corresponding transmitting and receiving actions. The electrically conductive material routing is further used for detecting the touch position by means of the signal change on the routing when the man-machine interactive panel is the touch screen and the touch panel; and the electrically conductive material routing is further used for displaying the stimulation of the driving signal to change the image of the display screen when the man-machine interactive panel is the display screen.

In the implementation manner, the electrically conductive material routing in the two man-machine interactive panels forms a parallel electric field when the man-machine interactive panels of the two communication systems are overlapped; the electrically conductive material routing is equivalent to the antenna when the signal is transmitted to the man-machine interactive panel, and the signal can be transmitted from one man-machine interactive panel to the other man-machine interactive panel according to the capacitive sensing of the electrically conductive material routing.

When the communication device communicate in the prior art, the corresponding information is modulated to carrier (which is called as modulated information communication), and an electromagnetic field is generated by applying the modulated information communication to the antenna, so as to provide information communication, and the adopted antenna is coil-typed. The communication system stops generating the electromagnetic field after the corresponding information is transmitted to another communication system in an active communication mode. During communication, the safety of the electric signal is poor, and it is difficult to separate noise from signal after mixing as the electric signal is interfered by outside noises and various noises inside the communication system in the transmission process along the route, so as to reduce the communication quality. The longer the route is, the more the noise is accumulated.

According to the invention, the electrically conductive material routing is used as an antenna and the man-machine interactive panel is used as a transmitting/receiving end, the signal is small and the safety can be guaranteed; in addition, the touch screen has been widely applied on a mobile device, and the safe wireless data transmission communication can be achieved without additional chips.

The controller in the drive chip controls the overall operation and/or configuration of the touch control chip. The controller receives the signal data from one or more application software modules, wherein one or more application software is, such as one or more non-contact repeaters, one or more non-contact tags, one or more non-contact smart cards, any other machine readable medium obvious for technical staffs in the relevant fields in a condition without departing from the spirit and scope of the invention, or any combination therefor. The other machine readable media can include but not limited to: read-only memory (ROM), random access memory (RAM), disk memory medium, optical memory medium, flash memory device, electricity, light, sound or other kinds of propagation signals (such as, carrier, infrared signal and digital signal). The controller can also receive data from the user interface, wherein the user interface, such as touch screen display, alphanumeric keyboard, microphone, mouse, loudspeaker, and any other appropriate user interface obvious for the technical staffs in the relevant fields in the condition without departing from the spirit and the scope of the invention. The controller can further receive data from the application software device coupled to the communication device or other electric device.

When the drive chip is the touch control chip, the man-machine interactive panel is the touch screen, the touch screen is provided with a plurality of ITO routing, and the signal transmission of the system specifically comprises the steps of:

acquiring the signal of an application software module needing to transmit, and transmitting the signal to the drive chip; and

transmitting the signal through the ITO routing of the touch screen.

Correspondingly, the signal reception of the system specifically comprises the steps of:

receiving the signal through the ITO routing of the touch screen; and

transmitting the signal to the application software module through a controller through interface after processing.

The above is described only if the drive chip is the touch control chip. The electrically conductive material routing in the man-machine interactive panel is further used for detecting the touch position by means of the signal change on the routing when the chip is the touch control chip; and the electrically conductive material routing in the man-machine interactive panel is further used for displaying the stimulation of the driving signal to change the image of the display screen when the chip is the display drive chip.

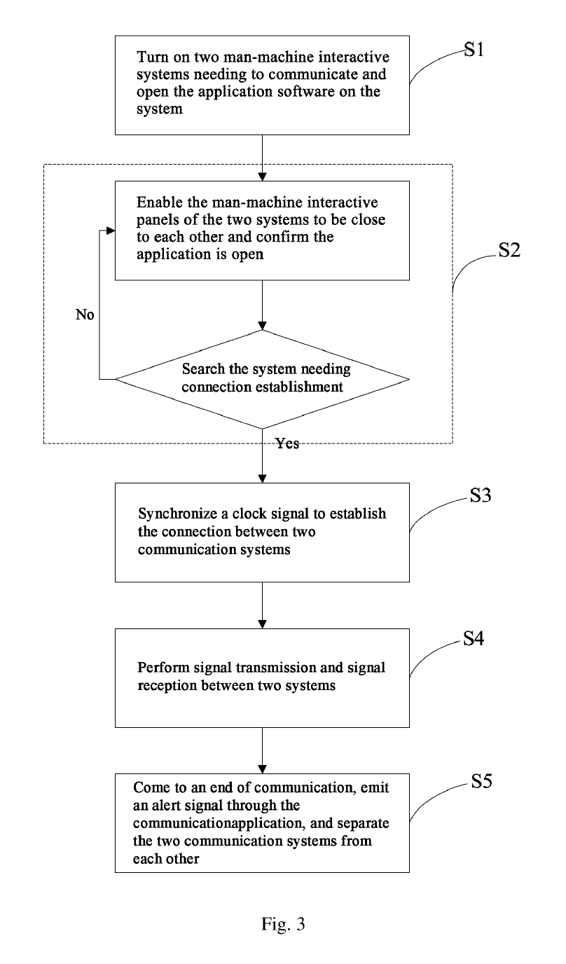

See FIG. 3 and with reference to FIG. 2, the communication method of the multi-functional man-machine interactive system in the invention comprises the following steps of:

S1. turning on two man-machine interactive systems needing to communicate and opening the application software on the system;

S2. enabling the man-machine interactive panels of the two systems to be close to each other, transmitting a communication request signal through the electrically conductive material and receiving a communication request signal of another system at the same time, receiving a signal of another signal through the transmission of the induction signal, judging whether searching the communication request signal of the system needing connection establishment, if so, performing step S3, and if not, re-performing step S2;

S3. synchronizing a clock signal to establish the connection between two systems;

S4. performing signal transmission and signal reception between two systems; and

S5. after successfully establishing the communication, emitting an alert signal through the communication application, prompting the successful communication establishment, completing the communication, and separating the two communication systems from each other.

The step S2 in the invention is a process of searching connection, which also needs to overlap the man-machine interactive panels of the two communication systems together, specifically as follows:

enabling the two systems needing to communicate to be close to each other, transmitting the communication request signal respectively through two communication systems, receiving the communication request signal of the opposite side respectively through two communication systems at the same time, and judging the researched system needing connection establishment if both two communication systems receive the receiving signal of the opposite side. Preferably, the connecting signal in the invention is a square signal. In other modes of execution, the other signals can also be used as the connecting signal to perform the connection search of the communication device.

The step S5 in the invention is a process of disconnecting, specifically as follows:

separating the two communication systems from each other, judging whether the two communication systems receive the connecting signal from the opposite side in the separation process, judging the two systems have been separated when the connecting signal is degraded and fails to receive, breaking off the communication, and emitting the alert signal through the system to prompt the communication outage. Preferably, the connecting signal in the invention is a square signal. In other modes of execution, the other signals can also be used as the connecting signal to perform the disconnection detection of the communication system.

Wherein, the “signal transmission” of the transmitting system in the step S4 specifically comprises:

acquiring the communication system of the application software needing to transmit, and transmitting the communication system to the drive chip; and

transmitting the communication signal to the electrically conductive material routing in the man-machine interactive panel through the drive chip, and performing the signal transmission through the electrically conductive material routing.

Correspondingly, the “signal reception” of the receiving system in step S4 specifically comprises the following steps of:

receiving the communication signal of the man-machine interactive panel on another system through the electrically conductive material routing in the man-machine interactive panel; and

transmitting the communication signal to the drive chip, and transmitting to the application software through the drive chip.

Compared to the prior art, the invention has the advantages as follows:

The existing drive chip interface circuit also only returns the signal data captured from the capacitive screen to the terminal device and cannot receive the communication request sent from the receiving terminal;

The existing touch device is not provided with the communication function, the active capacitive pen and the capacitive screen only unidirectionally transmit without data exchange. The touch device according to the invention has the two-way transmission capability;

The majority of the existing application software performs the data transmission by dispatching other communication devices, fails to dispatch the touch device for communication, only reads such data operated by touch as coordinate from the touch device unidirectionally, and has no data communication.

From the above technical schemes, it can be seen that the multi-functional interactive system and the communication method therefor according to the invention can achieve such various function as the man-machine interactive, induction and transmission and display. The man-machine interactive panel with the electrically conductive material routing is used as a transmitting/receiving end, the signal is small and the safety can be guaranteed; in addition, the man-machine interactive panel has been widely applied on a mobile device, and the safe wireless data transmission communication can be achieved without additional chips.

For convenient description, the various units are divided in function to describe respectively when describing the above devices. Of course, the function of various units can be achieved in the same one or more software and/or hardware when implementing the application.

Through the description of the above modes of execution, it can be seen that the technical staffs in the art can clearly understand that the application can be achieved by virtue of the software with the necessary general-purpose hardware platform. Based on such understanding, the technical scheme of the application can be essentially or the part making contributions to the prior art can be embodied in the form of the software product. The computer software product can be stored in the memory media, such as ROM/RAM, disk, CD and the like, including a plurality of commands for enabling one computer device (which can be a personal computer, a server, or a network device and the like) to execute various modes of execution of the application or the method of some parts of the modes of execution.

The modes of execution of the device described hereinabove are only schematic, wherein the unit noted as the separate parts can be or not be separated physically, the part displayed as the unit can be or also cannot be physical unit, which can be located in one place, or also can be distributed to a plurality of network units. Part of or all modules can be selected according to the actual need to achieve the object of the scheme of the implementation manner. Those common skilled in the art can understand and implement in the condition without giving creative work.

The application can be used in numerous general or special computing system environment or configuration. for example: personal computer, server computer, hand-held device or portable device, flat-plate device, multi-processor system, system based on microprocessor, set top box, programmable electronic equipment, network PC, minicomputer, large-scale computer, and distributed computing environment including above any system or device, etc.

The application can describe in the general context of the computer executable instruction executed by the computer, such as program module. Universally, the program module comprises a routine executing a special task or achieving a special abstract data type, program, object, component, data structure and the like. The application can also be practiced in the distributed computing environment in which the task is executed by a remote process unit connected through the communication network. In the distributed computing environment, the program module can be located in a local and remote computer memory medium including the memory device.

For those skilled in the art, the invention is obviously not limited to the details of the above demonstrative embodiments and can be achieved in other specific modes in a condition without departing from the spirit or basic feature of the invention. Therefore, the embodiments shall be deemed to be demonstrative and restrictive for every point. The scope of the invention is limited by the attached claims of right rather than the above description. As a result, all changes in the implication and the scope of the equivalent elements in the claims of right shall be aimed at pertaining to the invention. Any drawings and marks in the claims of right shall not be deems to limit the related claims of right.

In addition, it should be noted that not every implementation manner only comprises one independent technical scheme although the specification is described according to the implementation manner. The narrative mode of the specification is only for the purpose of understanding. Those skilled in the art shall take the specification as a whole, and the technical scheme in each embodiment can also be combined properly to form the other modes of execution that are understood by those skilled in the art.

1. A multi-functional human-machine interaction system, wherein the system comprises an application software module, a driving chip and a human-machine interaction panel, the application software module comprises application software performing signal induction and transmission based on a KISS system, the human-machine interaction panel comprises a plurality of conductive material routing, the conductive material routing is used for transmitting and receiving an inductive signal, and the driving chip comprises a touch chip and/or a display driving chip.

2. The multi-functional human-machine interaction system according to claim 1, wherein the human-machine interaction panel comprises a flexible or non-flexible touch screen and a display screen.

3. The multi-functional human-machine interaction system according to claim 2, wherein the human-machine interaction panel comprises a capacitive touch screen and a resistive touch screen, the touch panel comprises a capacitive touch panel and a resistive touch panel, and the display screen comprises an LCD.

4. The multi-functional human-machine interaction system according to claim 1, wherein the conductive material routing comprises ITO material routing, metal routing and carbon nanomaterial routing.

5. The multi-functional human-machine interaction system according to claim 2, wherein the conductive material routing is further used for detecting the touch position by means of the signal change on the routing when the human-machine interaction panel is the touch screen and the touch tablet; and the conductive material routing is further used for displaying the stimulation of the driving signal to change the image of the display screen when the human-machine interaction panel is the display screen.

6. A communication method of the multi-functional human-machine interaction system according to claim 1, wherein the method comprises the following steps of:
S1. turning on two human-machine interaction systems needing to communicate and opening the application software on the system;
S2. enabling the human-machine interaction panels of the two systems to be close to each other, transmitting a communication request signal through the conductive material and receiving a communication request signal of another system at the same time, receiving a signal of another signal through the transmission of the inductive signal, judging whether searching the communication request signal of the system needing connection establishment, if so, performing step S3, and if not, re-performing step S2;
S3. synchronizing a clock signal to establish the connection between two systems;
S4. performing signal transmission and signal reception between two systems; and
S5. after successfully establishing the communication, emitting an alert signal through the communication application, prompting the successful communication establishment, completing the communication, and separating the two communication systems from each other.

7. The communication method according to claim 6, wherein the “signal transmission” of the transmitting system in the step S4 specifically comprises the following sub-steps of:
acquiring the communication signal of the application software needing to transmit, and transmitting the communication signal to the driving chip; and
transmitting the communication signal to the conductive material routing in the human-machine interaction panel through the driving chip, and performing the signal transmission through the conductive material routing.

8. The communication method according to claim 6, wherein the “signal reception” of the receiving system in the step S4 specifically comprises the following sub-steps of:
receiving the communication signal of the human-machine interactive panel on another system through the conductive material routing in the human-machine interactive panel; and
transmitting the communication signal to the driving chip, and transmitting to the application software through the driving chip.

9. The communication method according to claim 6, wherein the step S2 specifically comprises the following sub-steps of:
enabling the two systems needing to communicate to be close to each other, transmitting the communication request signal respectively through two communication systems, receiving the communication request signal of the opposite side respectively through two communication systems at the same time, and judging the researched system needing connection establishment if both two communication systems receive the receiving signal of the opposite side.

10. The communication method according to claim 6, wherein the step S5 specifically comprises the following sub-steps of:
separating the two communication systems from each other, judging whether the two communication systems receive the connecting signal from the opposite side in the separation process, judging the two systems have been separated when the connecting signal is degraded and fails to receive, breaking off the communication, and emitting the alert signal through the system to prompt the communication outage.
